(19) United States
(12) Patent Application Publication
(10) Pub. No.: US 2020/0260704 A1
(43) Pub. Date: Aug. 20, 2020

(54) Fishing Lure

(71) Applicant: Max Scholfield, Durango, CO (US)

(72) Inventor: Max Scholfield, Durango, CO (US)

(21) Appl. No.: 16/277,033

(22) Filed: Feb. 15, 2019

(51) Int. Cl. A01K 85/16

(52) U.S. Cl. CPC A01K 85/16

(57) ABSTRACT

A fishing lure includes a lure body; a fishing hook inserted into the lure body such that an eye of the hook is disposed in the lure body; and a rivet assembled from a first part and a second part such that a shank of the rivet passes through the lure body and the eye.

### CROSS REFERENCE TO RELATED APPLICATIONS

Not Applicable.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of fishing lures. More specifically the disclosure relates to structures for fastening a fishing hook to a flexible lure body.

Fishing lures include many forms of plastic lure body made from flexible materials such as polyurethane. Such lure bodies may be molded into shapes resembling various bait species such as baitfish, crayfish, insects and other species attractive to fish. Various structures and methods may be used to connect or attach one or more fishing hooks to the lure body. See, for example, U.S. Pat. No. 9,253,566 issued to Scholfield.

Two issues considered in making such flexible body fishing lures are first that various devices for attaching a hook to a flexible lure body include pushing the hook through the lure body. Such attaching may provide limited strength of the lure body under load of a hooked fish or repetitive fishing line casting. Second, bait species intended to be mimicked by the lure generally have eyes, and a lure having eyes is therefore believed to be more realistic in appearance. Various means known in the art for simulating eyes, including affixing buttons and painting have inherent limitations.

### BRIEF DESCRIPTION OF THE DRAWINGS

FIG. 1 shows a side view of a fishing lure according to the present disclosure.

FIG. 1A shows a hook as may be used in the lure of FIG. 1.

FIG. 2 shows another view of a lure as in FIG. 1, wherein the lure body is oriented to show ends of a rivet used to attach the hook and simulate eyes.

FIG. 3 shows a disassembled view of a rivet that may be used in some embodiments.

### DETAILED DESCRIPTION

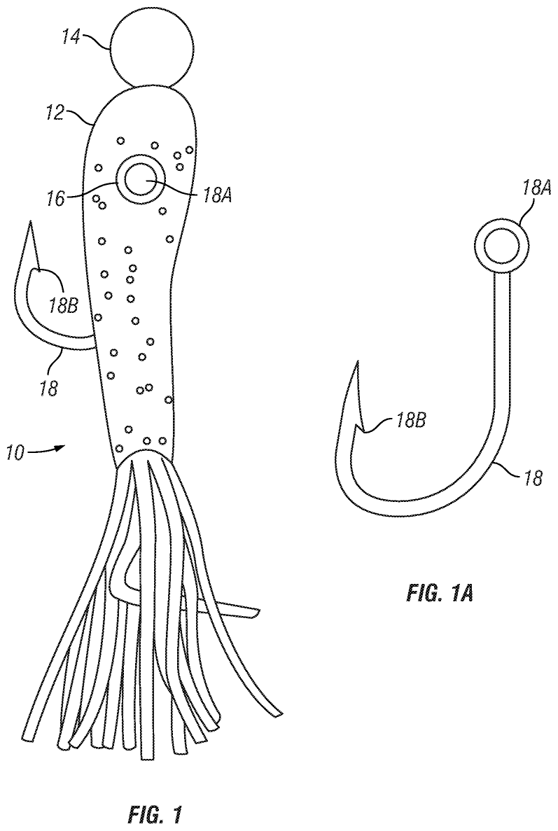

FIG. 1 shows an example embodiment of a fishing lure 10 according to the present disclosure. The fishing lure 10 may comprise a lure body 12, for example, molded from flexible plastic such as polyurethane into a shape resembling a bait species. A head end 14 of the lure body 14 may comprise a weight to provide the fishing lure 10 with preferred buoyancy and movement characteristics. A fishing hook 18 which comprises a barbed end 18B and an eye 18A at its other end. The eye 18B may be conventionally shaped such as, for example, attachment of fishing line or other devices. An example embodiment of the hook 18 is shown separately from the lure in FIG. 1A.

A fastener such as a clothing rivet 16, explained in more detail with reference to FIG. 3, may be affixed to the lure body 12 by passing the rivet shank (see FIG. 3) through the lure body 12, each part of the rivet being disposed on opposite sides of the lure body 12 so as to connect to each other within the lure body 12 through the eye 18A. Such rivets are known in the art to be used for assembling or fastening together components of clothing such as may be made from denim and leather.

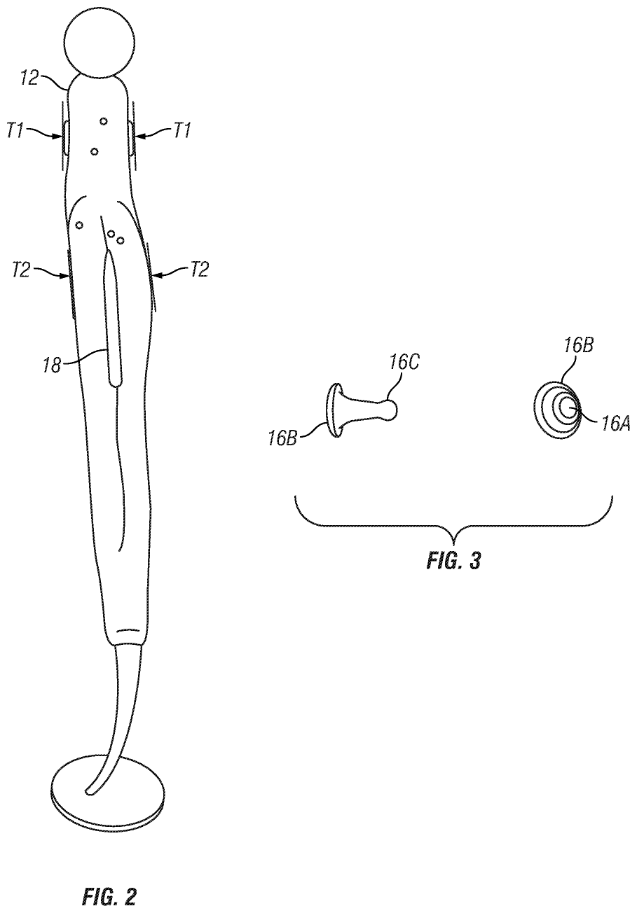

FIG. 2 shows the lure of FIG. 1 wherein the view is rotated 90 degrees to make apparent how the parts of the rivet 16 are passed through the lure body 12. In the present example embodiment, a thickness T1 defined between the rivet heard (FIG. 3) when the parts of the rivet are assembled may be less than an uncompressed thickness T2 of the lure body 12. Thus assembled, the rivet 12 may reinforce the lure body 12 and provide increased pull out strength to the hook 18 from the lure body 12.

FIG. 3 shows an example embodiment of a clothing rivet 12 used in embodiments of a fishing lure according to the present disclosure. The rivet (16 in FIG. 1) may comprise a first part comprising a shank with a locking feature 16C at one end, terminated at a rivet head 16B at the other end. A second part may comprise a rivet head 16B having a receptacle 16A arranged to mate with and lock to the locking feature 16C on the shank. When the first and second parts are assembled, a distance between the rivet heads 16B may be equal to the distance T1 described with reference to FIG. 2. A diameter of the shank may be small enough to fit through the eye (18A in FIG. 1) of the hook (18 in FIG. 1) as explained above. The rivet heads 16B may have a diameter proportionate to the size of the lure body (12 in FIG. 1). The material, color and finish of the rivet 16 may be at the discretion of the user and may be chosen to enhance the natural appearance of the bait species mimicked by the fishing lure.

In some embodiments, the rivet heads 16B may be finished such as by painting to more closely resemble eyes of the bait species mimicked by the fishing lure. A fishing lure made according to the various aspects of the present disclosure may provide more realistic and more durable eye like features of a bait species, and may have stronger and more durable attachment of a fishing hook to the lure body. The described fishing lure may also have better maintenance of bait position on the hook, reducing bait bunching.

Although only a few examples have been described in detail above, those skilled in the art will readily appreciate that many modifications are possible in the examples. Accordingly, all such modifications are intended to be included within the scope of this disclosure as defined in the following claims.

What is claimed is:

1. A fishing lure, comprising:
a lure body;
a fishing hook inserted into the lure body such that an eye of the hook is disposed in the lure body; and
a rivet assembled from a first part and a second part such that a shank of the rivet passes through the lure body and the eye.

2. The fishing lure of claim 1 wherein the rivet comprises a rivet head on each of the first part and the second part.

3. The fishing lure of claim 2 wherein the rivet heads define a first thickness when the first part and the second part are assembled, the first thickness less than an uncompressed thickness of the lure body.

4. The fishing lure of claim 1 wherein the lure body comprises flexible plastic.

5. The fishing lure of claim 4 wherein the flexible plastic comprises polyurethane.
